(19) United States
(12) Patent Application Publication
(10) Pub. No.: US 2013/0320259 A1
(43) Pub. Date: Dec. 5, 2013

(54) SOLVENT, PROCESS FOR PROVIDING AN ABSORPTION LIQUID, AND USE OF THE SOLVENT

(71) Applicants: Björn Fischer, Frankfurt a.M. (DE); Ralph Joh, Seligenstadt (DE); Rüdige Schneider, Eppstein (DE)

(72) Inventors: Björn Fischer, Frankfurt a.M. (DE); Ralph Joh, Seligenstadt (DE); Rüdige Schneider, Eppstein (DE)

(21) Appl. No.: 13/979,701

(22) PCT Filed: Jan. 12, 2012
(86) PCT No.: PCT/EP12/50439

§ 371 Date: Aug. 21, 2013

(30) Foreign Application Priority Data
Jan. 31, 2011 (EP) 11152684.4

(51) Int. Cl. B01D 53/62

(52) U.S. Cl. CPC B01D 53/62
USPC 252/189

(57) ABSTRACT

A solvent for selective absorption of CO₂ from the flue gas from a combustion plant is provided. The solvent includes an aqueous solution of a secondary amine an active scrubbing substance and an additive, the additive including a salt of vitamin C or E. A process for providing an absorption liquid, and to the use of the solvent for selective absorption of CO₂ from the flue gas from a combustion plant is also provided.

### CROSS REFERENCE TO RELATED APPLICATIONS

This application is the US National Stage of International Application No. PCT/EP2012/050439 filed Jan. 12, 2012 and claims benefit thereof, the entire content of which is hereby incorporated herein by reference. The International Application claims priority to the European Patent Office application No. 11152684.4 EP filed Jan. 31, 2011, the entire contents of which is hereby incorporated herein by reference.

### FIELD OF INVENTION

A solvent for selective absorption of CO₂ from the flue gas of a combustion plant is provided. The solvent includes an aqueous solution of a secondary amine as an active scrubbing substance and an additive. A process for providing an absorption liquid is also provided.

### BACKGROUND OF INVENTION

In fossil-fired power plants for generation of electrical energy, the combustion of a fossil fuel gives rise to a carbon dioxide-containing flue gas. To avoid or to reduce carbon dioxide emissions, carbon dioxide has to be removed from the flue gases. In general terms, various methods are known for removal of carbon dioxide from a gas mixture. The method of absorption-desorption is commonly used particularly for removal of carbon dioxide from a flue gas after an incineration operation. On the industrial scale, carbon dioxide (CO₂) is scrubbed out of the flue gas with an absorption liquid (CO₂ capture operation).

Standard absorption liquids (solvents) are based on primary, secondary or tertiary amines and exhibit a good selectivity and a high capacity for carbon dioxide CO₂. The main aim in flue gas scrubbing is the reduction in the level of carbon dioxide, which is harmful to the climate. The operation used for this purpose should, however, not cause any further emissions which can damage the environment or humans.

However, a more serious problem arises in the CO₂ capture operation as a result of the combination of the amines from the absorption liquid with the nitrogen oxides (NOₓ) from the flue gas from the combustion plant. Even though the concentration of nitrogen oxides in the flue gas is comparatively low, amines with nitrogen oxides form nitrosamines (N-nitroso compounds) which are carcinogenic to living organisms directly, through degradation products or via side reactions. The nitrosamines formed may have a low vapor pressure, and they can therefore also be discharged into the atmosphere via the cleaned flue gas.

There is a high public awareness of nitrosamines, since they can occur in foods (especially in the event of improper preparation), and the predominant number thereof are considered to be carcinogenic. Therefore, nitrosamines are at the focus of the current discussion about low-carbon dioxide power plants, and are relevant to safety for the operation with amine-based solvents Minimization of the nitrosamine concentration in the CO₂ capture operation is therefore of great importance for the public acceptance of the technology.

Only the nitrosamines formed from secondary amines are stable for any period. The primary nitrosamines react further to give alkenes and alcohols (Lehrbuch der organischen Chemie [Organic Chemistry]; Beyer and Walter, 1991), which are much less of a concern than the carcinogenic nitrosamines. Tertiary amines can react to give stable nitrosamine compounds only through their decomposition products, secondary amines. The reason why secondary amines are nevertheless preferred over the primary amines in CO₂ capture plants is the lower binding energy and hence a lower loss of efficiency in the overall power plant. Moreover, secondary amines exhibit a much higher loading capacity for CO₂ compared to primary amines Tertiary amines have the disadvantage that they react very slowly with carbon dioxide and thus require large columns.

In the case of gas scrubbing in the chemical industry, there is usually no occurrence of the problem since the nitrosating substance (nitrogen dioxide, or nitrogen monoxide which is to be oxidized to nitrogen dioxide) is generally not present, as a result of which there is also no possibility of nitrosation. In some operations, for example the tire industry, inhibitors are deliberately added to the operation in order to prevent the formation of the N-nitroso components. In the food industry, there are some known and effective inhibitors, for example selenium. However, the acidic medium present therein differs distinctly from the alkaline conditions in the CO₂ deposition. In the CO₂ deposition operation, these inhibitors, if they are effective at all under the conditions of a CO₂ capture operation, would have to be initially charged in large amounts in order to compete against the amine present in high concentration in the reaction with the nitrosating reagent. A disadvantage for the CO₂ capture operation is the large burden of inactive substance (inhibitor) in the process circuit, which additionally has to be pumped in circulation and thus lowers the efficiency of the power plant further.

### SUMMARY OF INVENTION

It is an object of the invention to specify a solvent comprising a secondary amine with distinctly reduced formation of nitrosamines on contact with nitrogen dioxide. It is a further object of the invention to specify a process for providing an absorption liquid with reduced formation of nitrosamines. It is a further object of the invention to specify a use of a solvent for selective absorption of CO₂ from the flue gas from a combustion plant. In addition, the disadvantages from the prior art are to be avoided.

The object of the invention directed to a solvent is achieved by a solvent comprising an aqueous solution of a secondary amine and an additive, wherein the additive comprises a salt of vitamin C or E (inhibitor).

The invention makes use of the fact that nitrogen dioxide reacts much more quickly with a salt of vitamin C or E than with a secondary amine This preferentially results in the formation of a nitrite ester and subsequent NO outgassing. The reaction of the nitrogen dioxide with the secondary amines proceeds relatively slowly compared to the reaction with salts of vitamins (e.g. sodium ascorbate), such that the invention distinctly inhibits the formation of stable secondary nitrosamines. The result of this is that even a small addition of a salt of vitamin C or E to the solvent allows the formation of stable nitrosamine compounds to be reduced to a high degree. In particular, the rapid reaction of the inhibitor results in a considerable reduction in nitrosamine formation even when added in a small amount. The strength of the inhibition depends on the amount of salt of vitamin C or E and the reaction rate thereof with the nitrosating substance which has been added to the solvent through the additive. It has been found to be advantageous to add a salt of vitamin C or E in the additive in the lower percent range (percent by weight), based on the amount of secondary amine.

The particular insight of the invention is that the salts of vitamin C or E can be used advantageously for the CO₂ capture operation. This is because, unexpectedly, the amount of salt of vitamin C or E required for effective inhibition is very small, and so the pumped circulation of solvent in the CO₂ capture operation is increased only slightly. In addition, the salts of vitamin C or E are unexpectedly suitable for the CO₂ capture operation since they are stable under the conditions present (alkaline medium and temperatures of >100° C.). In addition, the salt character of the vitamins ensures that neither the inhibitor itself nor the degradation products thereof can be discharged with the cleaned flue gas.

The invention considerably reduces the complexity for special measures involved in handling the nitrosamine-forming solvent. The amines used may be alkanolamines, sterically hindered amines, amino acids or amino acid salts. The secondary amine in the solvent is the primary active scrubbing substance in the absorbent.

An advantageous ratio between secondary amine and the salt of vitamin C or E has been found to be between 99:1 and 99.99:0.01, and more advantageously between 99.1:0.1 and 99.5:0.5. The ratio is based on percentages by weight. The aim of the addition of the additive is mainly distinct inhibition of the formation of stable nitrosamines. The salt of vitamin C or E in the additive achieves this aim.

In an advantageous configuration, the secondary amine is an amino acid salt. In a further advantageous configuration, the salt of vitamin C is sodium ascorbate. Amino acid salts have the advantage over other amines, such as alkanolamines, sterically hindered amines or amino acids, that they do not have any noticeable vapor pressure. The inventive solvent can be employed particularly advantageously in the case of amino acid salts, since the subsequent purification or the destruction of the stable nitrosamines is much more difficult in the case of amino acid salts than in comparison to conventional amines such as the alkanolamines or sterically hindered amines. In the case of alkanolamines, one option is distillation for the purification. Due to the lack of vapor pressure, in contrast, this is not possible for amino acid salts. These can be separated from the nitrosamines only by crystallization of the salt.

This object directed to a process is achieved by a process for providing an absorption liquid, in which an aqueous solution is made up with a secondary amine, and an additive is introduced into the aqueous solution, the additive comprising a salt of vitamin C or E.

The additive may also include further constituents.

An advantageous ratio between the secondary amine and the salt of vitamin C or E has been found to be between 99:1 and 99.99:0.01, and more advantageously between 99.1:0.1 and 99.5:0.5.

In the case of a particular application of the process, the secondary amine dissolved in the aqueous solution is an amino acid salt. The salt of vitamin C dissolved is advantageously sodium ascorbate.

The object of the invention directed to a use is achieved by the use of a solvent for selective absorption of CO₂ from the flue gas from a combustion plant, wherein the solvent comprises an aqueous solution of a secondary amine and an additive, said additive comprising a salt of vitamin C or E. The combustion plant may be a fossil-fired steam power plant, a gas turbine plant, or a combined gas and steam turbine plant.

### BRIEF DESCRIPTION OF THE DRAWINGS

Working examples of the invention are illustrated in detail hereinafter with reference to figures. The figures show:

FIG. 1 a diagram showing the rate of formation of nitrosamines over time,

FIG. 2 a possible reaction route for the sodium ascorbate with nitrite as an example of a nitrosating substance,

FIG. 3 an example of a secondary amine,

FIG. 4 an alternative example of a secondary amine.

### DETAILED DESCRIPTION OF INVENTION

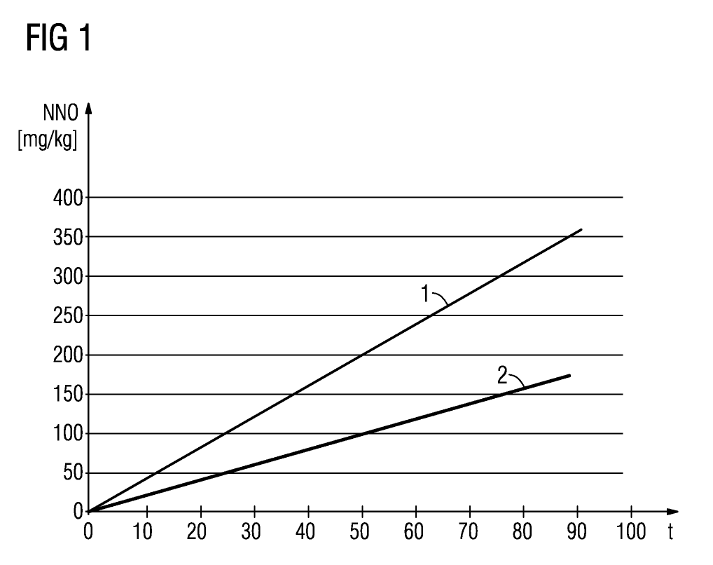

The diagram shown in FIG. 1 shows the rate of formation of stable nitrosamines (NNO) in mg per kg over time. The upper function shows, in schematic form, the rate of formation of a solvent 1 comprising a secondary amine 4 as the active scrubbing substance. There is a clear rise in the nitrosamines 5 over time, i.e. in conjunction with the solvent comprising the CO₂-containing flue gas. The nitrosamine concentration rises up to the equilibrium of the reaction of the stable nitrosamines in the solvent 1 (not evident in the diagram). The lower function shows a solvent 2 comprising the same secondary amine 4 and an additive 6 comprising a salt of vitamin C or E 3. The ratio between secondary amine 4 and salt of vitamin C or E 3 in this working example is 99.5:0.5. The functions show that the rate of formation in the case of a solvent comprising an additive 6 comprising a salt of vitamin C or E 3 is much lower compared to a solvent comprising a purely secondary amine 4. With increasing concentration of salt of vitamin C or E 3, the formation of nitrosamines 5 can be inhibited further.

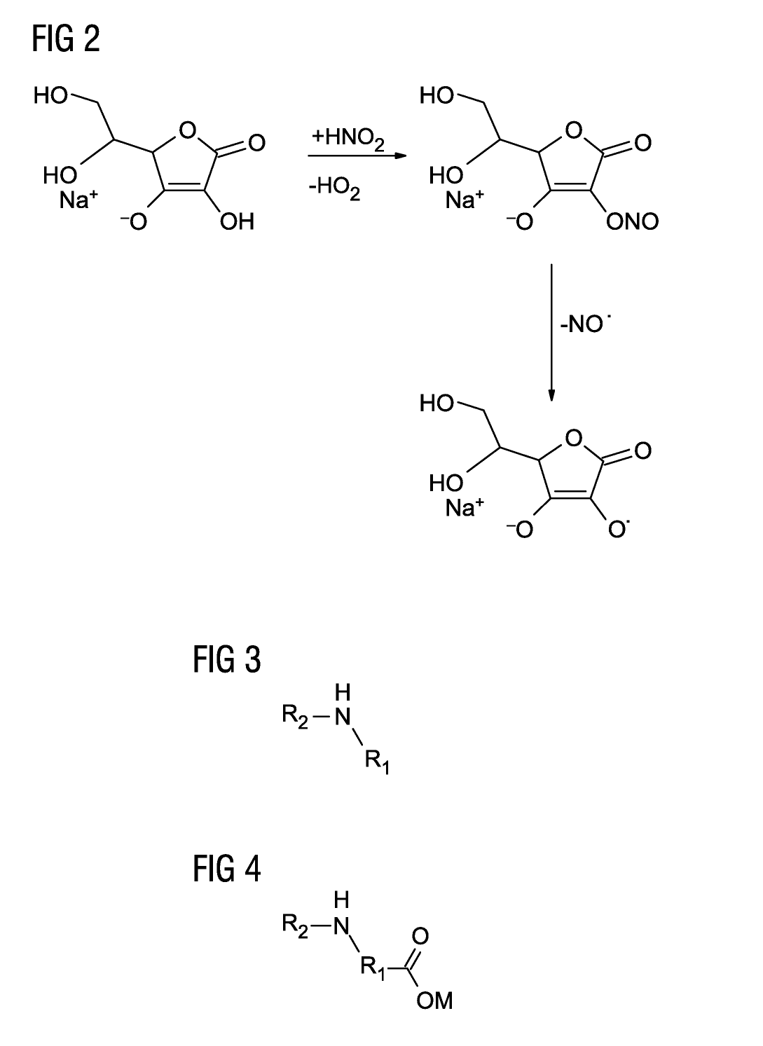

FIG. 2 shows a diagram of a possible reaction route of sodium ascorbate (sodium salt of vitamin C) with nitrite as a nitrosating substance. The sodium ascorbate reacts with the dissolved nitrite with release of water to give a nitrite ester, which reacts through elimination of NO (which outgases) to give a semiquinone. Further reactions are possible. Overall, sodium ascorbate has to be replenished continuously at the rate at which it is consumed by the reaction with nitrite.

FIG. 3 and FIG. 4 show illustrative secondary amines FIG. 3 shows a secondary amine where R1 and R2 are each hydrogen, alkyl, aryl, hydroxyalkyl or haloalkyl. FIG. 4 shows a secondary amine where R1 and R2 are each alkyl, aryl, hydroxyalkyl, haloalkyl and M is Na, K, Li, Mg, Ca or Be.

1-9. (canceled)

10. A solvent, comprising:
an aqueous solution of a secondary amine and an additive,
wherein the additive comprises a salt of vitamin C or E, and
wherein the secondary amine is an amino acid salt.

11. The solvent as claimed in claim 10, wherein the ratio between the secondary amine and the salt of vitamin C or E is between 90:10 and 99.99:0.01.

12. The solvent as claimed in claim 10, wherein the salt of vitamin C is sodium ascorbate.

13. A process for providing an absorption liquid, comprising:
providing an aqueous solution with a secondary amino acid salt; and
introducing an additive into the aqueous solution, the additive comprising a salt of vitamin C or E.

14. The process as claimed in claim 12, wherein the ratio between secondary amine and the salt of vitamin C or E is adjusted to between 80:20 and 99:1.

15. The process as claimed in claim 12, wherein the salt of vitamin C is sodium ascorbate.

16. An absorption liquid produced as claimed in claim 12.
